(19) United States
(12) Patent Application Publication
(10) Pub. No.: US 2025/0330080 A1
(43) Pub. Date: Oct. 23, 2025

(54) CONTROL CIRCUIT AND POWER SUPPLY DEVICE

(71) Applicant: FUJI ELECTRIC CO., LTD., Kanagawa (JP)

(72) Inventors: Hiroaki MATSUMOTO, Matsumoto-city (JP); Yukihiro YAGUCHI, Matsumoto-city (JP); Hiroyuki NAKAJIMA, Matsumoto-city (JP)

(21) Appl. No.: 19/087,562

(22) Filed: Mar. 23, 2025

(30) Foreign Application Priority Data
Apr. 22, 2024 (JP) 2024-069216
Jan. 30, 2025 (JP) 2025-014408

(51) Int. Cl. H02M 1/08; H02M 3/335

(52) U.S. Cl. CPC H02M 1/08; H02M 3/33569

(57) ABSTRACT

A control circuit is provided, which controls, for a power supply circuit, a switching operation of a first switching element which controls a first current and a second switching element which controls a second current, the power supply circuit including the first switching element and the second switching element, the control circuit including a phase detection circuit which generates a phase difference signal which indicates a phase difference between the first current and the second current and a phase compensation circuit which adjusts a second phase, at which the second switching element operates, relative to a first phase, at which the first switching element operate, based on the phase difference signal and the duration of the ON period of the second switching element.

The contents of the following patent application(s) are incorporated herein by reference:
NO. 2024-069216 filed in JP on Apr. 22, 2024 and
NO. 2025-014408 filed in JP on Jan. 30, 2025

### BACKGROUND

### 1. Technical Field

The present invention relates to a control circuit and a power supply device.

### 2. Related Art

A power factor correction circuit (hereinafter, referred to as PFC) that operates in a critical mode improves the power factor of a power supply by making the waveform of the peak value of an inductor current flowing through an inductor similar to the rectified voltage obtained by rectifying AC voltage. In this case, the PFC circuits of several systems may perform an interleave operation (for example, Patent Documents 1-7, and Non-Patent Document 1).
Patent Document 1: Japanese Patent Application Publication No. 2022-041912
Patent Document 2: International Publication No. 2008/032768
Patent Document 3: Japanese Patent Application Publication No. 2010-119285
Patent Document 4: International Publication No. 2011/122172
Patent Document 5: Japanese Patent Application Publication No. 2016-086463
Patent Document 6: Japanese Patent Application Publication No. 2011-229364
Patent Document 7: Japanese Patent Application Publication No. 2010-016973
Non-Patent Document 1: Electronic Devices Division, Applied Technology Department, “MH2501SC/MH2511SC Application Note Ver. 3.0”, Shindengen Co., Ltd., Nov. 11, 2020, FIGS. 8, 9, Waveform 2, p. 9-10, p. 20

### BRIEF DESCRIPTION OF THE DRAWINGS

FIG. 1 is a diagram illustrating a configuration example of a power supply device 200 according to one embodiment of the present invention.

FIG. 2 is a diagram illustrating an example of a time waveform of a first current I_{L1} in a current critical mode.

FIG. 3 is a diagram illustrating an example of a time waveform of the first current I_{L1}, a second current I_{L2}, and a sum current I_{L1}+I_{L2} in the case of an operation in a single method and an interleaved method.

FIG. 4 is a diagram illustrating the overview of a control circuit 100.

FIG. 5 is a diagram illustrating an example of a time waveform of an AC voltage Vac, a PI signal, a ramp signal, a first output signal OUT1, and a first current I_{L1}.

FIG. 6 is a block diagram indicating an example of a second control signal generation unit 150.

FIG. 7 is a timing chart illustrating an exemplary operation of the second control signal generation unit 150.

FIG. 8 is a diagram illustrating an example of the restriction on an ON width adjustment amount ΔTon in an ON width adjustment circuit 174.

FIG. 9 is a diagram illustrating an integral manner.

FIG. 10 is a timing chart illustrating an example of each signal in the control circuit 100 in more detail.

FIG. 11 illustrates an example of a time waveform of an input current in an implementation example in which the magnitude of the adjustment amount ΔTon is restricted according to an ON width Ton and a comparative example in which it is not restricted.

FIG. 12 is a diagram illustrating another configuration example of the phase detection circuit 160 and the phase compensation circuit 170.

FIG. 13 is a timing chart illustrating an exemplary operation of the phase detection circuit 160 and the phase compensation circuit 170 in the example in FIG. 12.

FIG. 14 is a timing chart illustrating another exemplary operation of the phase detection circuit 160 and the phase compensation circuit 170.

### DESCRIPTION OF EXEMPLARY EMBODIMENTS

Hereinafter, embodiments of the present invention will be described. However, the following embodiments are not for limiting the invention according to the claims. In addition, not all of the combinations of features described in the embodiments are essential to the solution of the invention.

In the present specification, the magnitude or the like of a resistance value, a current value, a voltage value, or other parameters may be described as equal or the same. These parameters being equal or the same is not limited to being completely equal, but these parameters may be different to the extent that they do not deviate from the scope of the invention according to the present specification. For example, being equal or the same allows for errors within 10%.

In the present specification, “circuit” does not only include an analog circuit or a logic circuit of a wired logic type but also a functional block (or means) that can perform a digital operation process and is included in a digital signal processor (DSP), a microcomputer, or the like.

In the description of the circuit, the description that an element C is provided “between” an element A and an element B means that the element C is provided between the element A and the element B in a current path. The above description imposes no limitation on the spatial position of the element C.

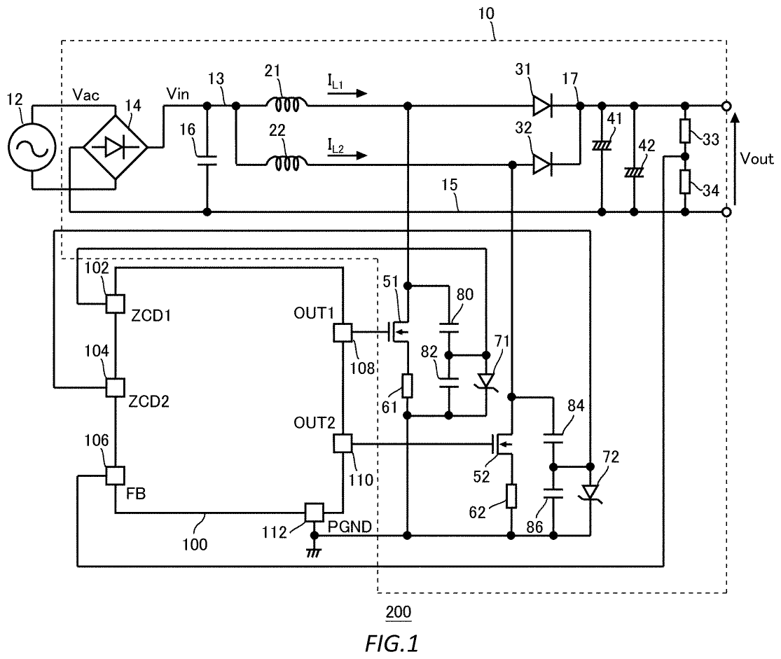

FIG. 1 is a diagram illustrating a configuration example of a power supply device 200 according to one embodiment of the present invention. A power supply device 200 in the present example functions as an AC-DC convertor. The power supply device 200 in the present example includes a power supply circuit 10 and a control circuit 100. The power supply circuit 10 generates an output voltage Vout of direct current depending on the predetermined target level from an AC voltage Vac that is input from an external power supply 12. The power supply 12 is, for example, a commercial power supply. The control circuit 100 controls the operation of the power supply circuit 10. The control circuit 100 may have a function as a PFC circuit that improves the power factor in the power supply circuit 10.

The power supply circuit 10 includes a first inductor 21, a second inductor 22, a first switching element 51, and a second switching element 52. An input voltage Vin obtained by rectifying the AC voltage Vac is input to the first inductor 21. The current flowing through the first inductor 21 is referred to as a first current I_{L1}. The second inductor 22 is provided in parallel with the first inductor 21. An input voltage Vin obtained by rectifying the AC voltage Vac is input to the second inductor 22. The current flowing through the second inductor 22 is referred to as a second current I_{L2}.

The first switching element 51 controls the first current I_{L1} flowing through the first inductor 21. The first switching element 51 in the present example, provided between the first inductor 21 and a reference potential PGND, switches whether to connect the first inductor 21 to the reference potential PGND.

The second switching element 52 controls the second current I_{L2} flowing through the second inductor 22. The second switching element 52 in the present example, provided between the second inductor 22 and a reference potential PGND, switches whether to connect the second inductor 22 to the reference potential PGND. The power supply circuit 10 outputs the sum current of the current depending on the first current I_{L1} and the current depending on the second current I_{L2}.

The power supply circuit 10 in the present example further includes a low potential line 15, a high potential line 13, a full-wave rectifying circuit 14, a capacitor 16, a first capacitor 41, a second capacitor 42, a first diode 31, a second diode 32, and voltage dividing resistors 33, 34. The full-wave rectifying circuit 14 performs full wave rectification on the input AC voltage Vac for output as the input voltage Vin. Note that the AC voltage Vac is, for example, the voltage with the effective value of 100 to 240 V and the frequency of 50 to 60 Hz.

The capacitor 16 is provided between the high potential line 13 and the low potential line 15. The capacitor 16 smooths the input voltage Vin. The smoothed input voltage Vin is applied to the first inductor 21 and the second inductor 22 in the present example.

The anode of the first diode 31 is connected to the first inductor 21, which charges the first capacitor 41 with the current depending on the first current I_{L1}. In the present specification, a positive value of the first current I_{L1} causes the current to flow from the first inductor 21 to the first diode 31. The node between the anode of the first diode 31 and the first inductor 21 is connected to the first switching element 51. The first switching element 51 repeatedly turns on/off so that the first inductor 21, the first diode 31, the first capacitor 41, and the first switching element 51 function as a boost chopper circuit.

The anode of the second diode 32 is connected to the second inductor 22, which charges the second capacitor 42 with the current depending on the second current I_{L2}. In the present specification, a positive value of the second current I_{L2} causes the current to flow from the second inductor 22 to the second diode 32. The node between the anode of the second diode 32 and the second inductor 22 is connected to the second switching element 52. The second switching element 52 repeatedly turns on/off so that the second inductor 22, the second diode 32, the second capacitor 42, and the second switching element 52 function as a boost chopper circuit.

The cathode of the first diode 31 and the cathode of the second diode 32 are connected to the node 17. Consequently, the sum current of the current depending on the first current I_{L1} and the current depending on the second current I_{L2} flows through the node 17.

The first capacitor 41 and the second capacitor 42 are provided in parallel with each other between the node 17 and the low potential line 15. The charge voltages of the first capacitor 41 and the second capacitor 42 are output as the output voltage Vout of direct current. Although the first capacitor 41 and the second capacitor 42 in FIG. 1 are electrolytic capacitors, they may be other types of capacitors. In addition, although the first capacitor 41 and second capacitor 42 are illustrated as being separated in FIG. 1, one capacitor may be provided into which the first capacitor 41 and the second capacitor 42 are integrated.

The voltage dividing resistor 33 and the voltage dividing resistor 34 are provided in series between the node 17 and the low potential line 15. The voltage dividing resistor 33 and the voltage dividing resistor 34 input the feedback voltage FB, which is obtained by dividing the output voltage Vout depending on the resistance ratio, into the feedback terminal 106 of the control circuit 100. The control circuit 100 controls the switching operation of the first switching element 51 and the second switching element 52 depending on the feedback voltage FB to adjust the output voltage Vout to a predetermined target level.

The power supply circuit 10 may further include a first resistance 61, a second resistor 62, capacitors 80, 82, 84, 86, a diode 71 and a diode 72. The first resistance 61 is provided between the first switching element 51 and the reference potential PGND. The second resistor 62 is provided between the second switching element 52 and the reference potential PGND.

The capacitor 80 and the capacitor 82 are connected in series to each other. In the present example, the capacitor 80 is arranged on the high-pressure side and the capacitor 82 is arranged on the low-pressure side. The capacitor 80 and the capacitor 82 are provided in parallel with the first switching element 51 and the first resistance 61. The diode 71 is connected in parallel with the capacitor 82. The anode of the diode 71 is connected to the node between the capacitor 80 and the capacitor 82 and the cathode is connected to the reference potential PGND. At the node between the capacitor 80 and the capacitor 82, a voltage ZCD1 is generated depending on the source-drain voltage of the first switching element 51. The voltage ZCD1 is the voltage depending on the first current I_{L1}. The voltage ZCD1 is input to the input terminal 102 of the control circuit 100.

The capacitor 84 and the capacitor 86 are connected in series to each other. In the present example, the capacitor 84 is arranged on the high-pressure side and the capacitor 86 is arranged on the low-pressure side. The capacitor 84 and the capacitor 86 are provided in parallel with the second switching element 52 and the second resistor 62. The diode 72 is connected in parallel with the capacitor 86. The anode of the diode 72 is connected to the node between the capacitor 84 and the capacitor 86 and the cathode is connected to the reference potential PGND. At the node between the capacitor 84 and the capacitor 86, a voltage ZCD2 is generated depending on the source-drain voltage of the second switching element 52. The voltage ZCD2 is the voltage depending on the second current I_{L2}. The voltage ZCD2 is input to the input terminal 104 of the control circuit 100.

The control circuit 100 in the present example has an input terminal 102, an input terminal 104, a feedback terminal 106, an output terminal 108, an output terminal 110, and a reference potential terminal 112. The reference potential PGND is applied to the reference potential terminal 112.

The control circuit 100 generates the first output signal OUT1 and the second output signal OUT2 based on the voltage ZCD1, the voltage ZCD2, and the feedback voltage FB, which are input to the input terminal 102, the input terminal 104, and the feedback terminal 106. The first output signal OUT1 is input to the control terminal of the first switching element 51 and the second output signal OUT2 is input to the control terminal of the second switching element 52. The first switching elements 51, 52 in the present example are n channel MOFSETs.

The control circuit 100 in the present example is an integrated circuit that controls the switching operation of the first switching element 51 and the second switching element 52 such that the level of the output voltage Vout becomes the target level (for example, 400 V), while improving the input power factor of the power supply circuit 10.

In the power supply circuit 10, the boost chopper circuit including the first inductor 21 is referred to as a Phase-a, and the boost chopper circuit including the second inductor 22 is referred to as a Phase-b. The control circuit 100 may have a mode to control the power supply circuit 10 in an interleaved method in which the phases of the first current I_{L1} of the Phase-a and the second current I_{L2} of the Phase-b are different to each other by 180 degrees. In addition, the control circuit 100 may operate each phase (for example, the first switching element 51 and the second switching element 52) in the power supply circuit 10 in a so-called current critical mode (or also referred to as a critical mode).

The control circuit 100 in the present example adjusts the phase of the second current I_{L2} relative to the first current I_{L1} through the output signal OUT2 that is input to the second switching element 52. Consequently, for example, the phase difference between the first current I_{L1} and the second current I_{L2} in the case of the operation in an interleaved method is maintained to 180 degrees. However, a rapid change in the phase of the second current I_{L2} may disturb the waveform of the input current that is input to the first inductor 21 and the second inductor 22, decreasing the power factor. The control circuit 100 restricts the adjustment amount for the phase of the second current I_{L2} based on the ON width of the second switching element 52. Consequently, the phase difference between the first current I_{L1} and the second current I_{L2} can be maintained to a predetermined value, while preventing the decrease in the power factor. The restriction on the adjustment amount for the phase of the second current I_{L2} will be described later in detail.

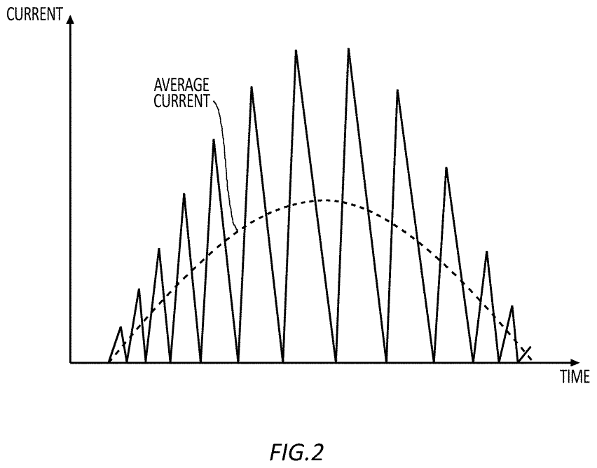

FIG. 2 is a diagram illustrating an overview of a time waveform of the first current I_{L1} in the current critical mode. The second current I_{L2} may also have a similar time waveform. The control circuit 100 controls the first switching element 51 to the ON state at the timing when the current value of the first current I_{L1} becomes 0. Consequently, the first current I_{L1} starts to increase. The control circuit 100 controls the first switching element 51 to the OFF state when a predetermined ON period elapses. Consequently, the first current I_{L1} starts to decrease. The ON period may be determined depending on the feedback voltage FB such that the output voltage Vout matches a predetermined target level. After turning off the first switching element 51, the control circuit 100 turns the first switching element 51 to the ON state again when the current value of the first current I_{L1} becomes 0. By repeating such a control, the control circuit 100 controls the switching operation of the first switching element 51.

If the capacitance of the first capacitor 41 or the second capacitor 42 is large enough, the feedback voltage FB is approximately constant during a period of about one periodic time of the AC voltage Vac. When the target level of the output voltage Vout is approximately constant during a period of about one periodic time of the AC voltage Vac, the ON period of the first switching element 51 is also approximately constant during the period of one periodic time of the AC voltage Vac.

When the first switching element 51 is turned on, a higher level of the input voltage Vin obtained by rectifying the AC voltage Vac leads to a greater current value of the first current I_{L1}. As a result, the waveform of the envelope connecting the peaks of the first current I_{L1} is similar to the input voltage Vin.

A higher level of the peak value of the first current I_{L1} leads to a longer time from when the first switching element 51 is turned off until the first current I_{L1} becomes zero. Therefore, a lower level of the input voltage Vin leads to a higher switching frequency of the first switching element 51 and a higher level of the input voltage Vin leads to a lower switching frequency of the first switching element 51.

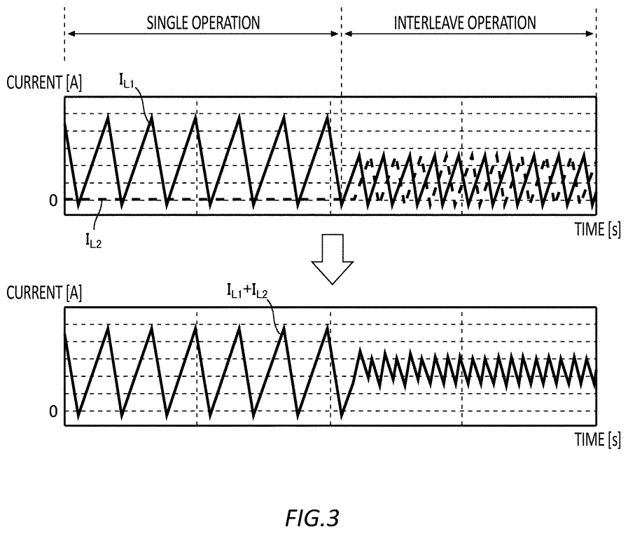

FIG. 3 is a diagram illustrating an example of a time waveform of the first current I_{L1}, the second current I_{L2}, and the sum current I_{L1}+I_{L2} in the case of an operation in a single method and an interleaved method. In the single method in the present example, the second switching element 52 is always in the OFF state and the second current I_{L2} does not flow. The sum current I_{L1}+I_{L2} in the single operation is the same as the first current I_{L1}.

In the interleaved method, the switching operations of the first switching element 51 and the second switching element 52 are controlled such that the phases of the first current I_{L1} and the second current I_{L2} are different by 180 degrees from each other. As a result, the frequency of the sum current I_{L1}+I_{L2} is approximately two times the frequency of the first current I_{L1}. In addition, the ripple current of the sum current I_{L1}+I_{L2} becomes smaller.

In the interleaved method, the switching loss is distributed among a plurality of switching elements (in the present example, the first switching element 51 and the second switching element 52). Accordingly, the load in one switching element can be mitigated, facilitating a thermal design or the like. In addition, since the ripple current in the sum current I_{L1}+I_{L2} can be smaller and the effective frequency can be higher, the filter size can be smaller when the sum current I_{L1}+I_{L2} is filtered.

On the other hand, in the interleaved method, the phase difference between the operations of each phase is preferably maintained to a predetermined value. In the interleaved method with two phases as in the present example, the phase difference is preferably maintained to 180 degrees. The control circuit 100 maintains the phase difference between the operations of each phase to a predetermined value by controlling the switching timing of respective switching elements.

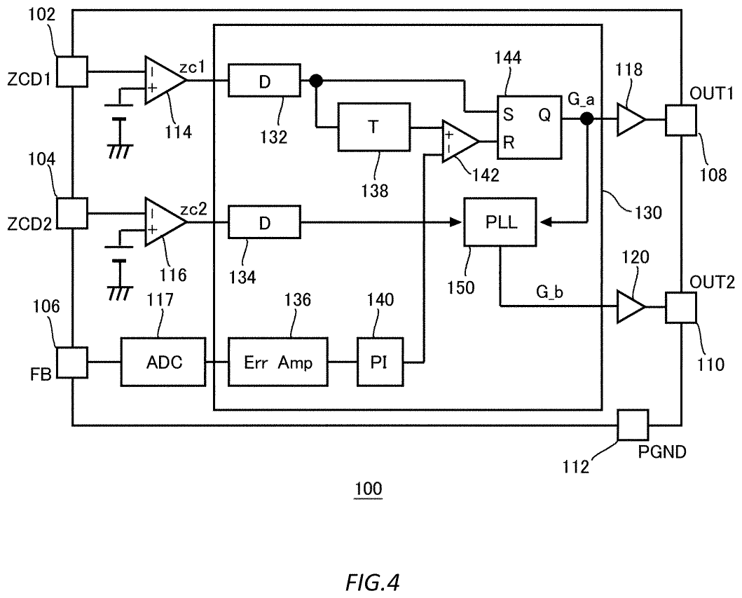

FIG. 4 is a diagram illustrating an overview of the control circuit 100. The control circuit 100 in the present example has a digital control unit 130, a comparator circuit 114, a comparator circuit 116, an AD conversion circuit 117, a buffer 118, and a buffer 120.

The comparator circuit 114 detects, based on the first current I_{L1}, the timing at which the first switching element 51 should be turned on. The comparator circuit 114 in the present example detects the timing at which the first current I_{L1} becomes approximately 0 A. Being approximately 0 A refers to the absolute value of the current value being or less than the value slightly greater than 0. The voltage ZCD1 depending on the first current I_{L1} and the reference voltage corresponding to approximately 0 A are input to the comparator circuit 114 in the present example. The comparator circuit 114 in the present example outputs a comparison result signal zc1 that indicates the H logic for the first current I_{L1} equal to or less than the reference current (approximately 0 A) corresponding to the reference voltage and indicates the L logic for the first current I_{L1} greater than the reference current.

The comparator circuit 116 detects, based on the second current I_{L2}, the timing when the second switching element 52 should be turned on. The comparator circuit 116 in the present example detects the timing at which the second current I_{L2} becomes approximately 0 A. The voltage ZCD2 depending on the second current I_{L2} and the reference voltage corresponding to approximately 0 A are input to the comparator circuit 116 in the present example. The comparator circuit 116 in the present example outputs the comparison result signal zc2 that indicates the H logic for the second current I_{L2} being equal to or less than the reference current corresponding to the reference voltage and indicates the L logic for the second current I_{L2} being greater than the reference current.

The AD conversion circuit 117 converts the feedback signal FB into a digital signal. The digital control unit 130 generates a first control signal G_a and a second control signal G_b based on the comparison result signal zc1, the comparison result signal zc2, and the digital feedback signal FB. The first control signal G_a is a signal indicating the switching timing of the first switching element 51. The second control signal G_b is a signal indicating the switching timing of the second switching element 52. Each control signal may be a signal that indicates the H logic during the period when the switching element is turned on and indicates the L logic during the period when the switching element is turned off.

The buffer 118 outputs the first output signal OUT1 depending on the first control signal G_a to the output terminal 108. The buffer 120 outputs the second control signal OUT2 depending on the second control signal G_b to the output terminal 110.

The digital control unit 130 in the present example has delay elements 132, 134, an error amplifier 136, a timer circuit 138, a PI control unit 140, a comparator circuit 142, a set reset latch circuit 144, and a second control signal generation unit 150. The delay element 132 delays the comparison result signal zc1 by a preset time for output. The signal that is output from the delay element 132 is input to the set terminal of the set reset latch circuit 144 and the timer circuit 138.

The timer circuit 138 outputs a ramp signal whose value gradually increases from the initial value, starting from the timing when the comparison result signal zc1 that is output from the delay element 132 transitions to the H logic. The timer circuit 138 may output a ramp signal whose value increases by a predetermined value depending on each pulse of the input clock signal.

The error amplifier 136 detects the magnitude of the difference between the level of the output voltage Vout and a predetermined target level. The error amplifier 136 in the present example senses the magnitude of the difference between the magnitude of the feedback signal FB and the reference value depending on the target level.

The PI control unit 140 outputs a PI signal depending on the magnitude of the difference sensed by the error amplifier 136. The PI signal is a signal for controlling the duration of the ON period for the first current I_{L1}. The PI control unit 140 outputs a PI signal such that the ON period becomes longer as the level of the output voltage Vout decreases with respect to the target level, and outputs a PI signal such that the ON period becomes shorter as the level of the output voltage Vout increases with respect to the target level. For example, the PI control unit 140 outputs a greater PI signal as the level of the output voltage Vout decreases with respect to the target level.

The comparator circuit 142 compares the magnitude of the ramp signal output by the timer circuit 138 to the magnitude of the PI signal. The comparator circuit 142 in the present example outputs a comparison result signal that indicates the L logic if the magnitude of the ramp signal is smaller than the magnitude of the PI signal, and indicates the H logic if the magnitude of the ramp signal is equal to or greater than the magnitude of the PI signal. Since the slope of the ramp signal is constant, a greater PI signal causes a greater delay in the timing at which the output of the comparator circuit 142 transitions from the L logic to the H logic. The comparison result signal of the comparator circuit 142 is input to the reset terminal of the set reset latch circuit 144.

The set reset latch circuit 144 outputs the first control signal G_a of the H logic from when the signal of the H logic is input to the set terminal until the signal of the H logic is input to the reset terminal. In addition, the set reset latch circuit 144 outputs the first control signal G_a of the L logic from when the signal of the H logic is input to the reset terminal until the signal of the H logic is input to the set terminal. The first switching element 51 is controlled to the ON state during a period when the first control signal G_a is the H logic, and the first switching element 51 is controlled to the OFF state during a period when the first control signal G_a is the L logic.

In other words, when the first current I_{L1} becomes approximately zero and the comparison result signal zc1 that is output from the delay element 132 transitions to the H logic, the first switching element 51 is turned on. In addition, after the turn-on, the first switching element 51 is maintained to the ON state during the ON period depending on the magnitude of the PI signal indicating the difference between the output voltage Vout and the target level. When the ON period elapses, a signal of the H logic is input to the reset terminal of the set reset latch circuit 144 and the first switching element 51 is turned off.

The delay element 134 delays the comparison result signal zc2 that is output from the comparator circuit 116 by a preset time for output. The delay amount in the delay element 134 may be the same as the delay amount in the delay element 132. The comparison result signal zc2 that is output from the delay element 134 indicates the timing at which the second switching element 52 should be turned on.

The second control signal generation unit 150 generates the second control signal G_b based on the comparison result signal zc2 that is output from the delay element 134 and the first control signal G_a. The second control signal generation unit 150 may detect, from the first control signal G_a, the period from the timing when the first switching element 51 is turned on until the timing when it is turned on next time. The second control signal generation unit 150 generates the second control signal G_b such that the second switching element 52 is turned on at the timing in the midpoint of the period. Consequently, the phase difference between the operation phase of the first switching element 51 and the operation phase of the second switching element 52 can be maintained to 180 degrees.

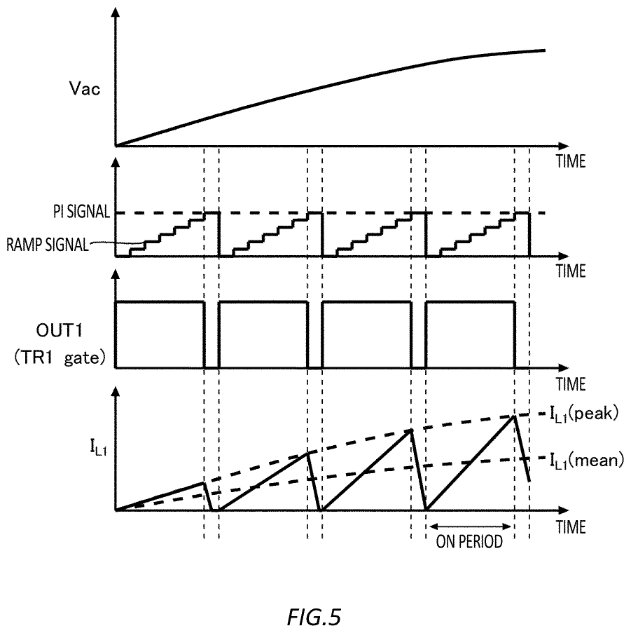

FIG. 5 is a diagram illustrating an example of a time waveform of an AC voltage Vac, a PI signal, a ramp signal, a first output signal OUT1, and a first current I_{L1}. The voltage value of the AC voltage Vac in the present example gradually increases.

The PI signal in the present example has a constant magnitude. In addition, the ramp signal starts to gradually increase from the initial value at the timing when the first current I_{L1} becomes approximately 0 and the comparison result signal zc1 of the delay element 132 (see FIG. 4) transitions to the H logic. The ramp signal may be a signal to which a predetermined level is added each time the pulse of the clock signal is input to the timer circuit 138. The ramp signal In this case has a step-like waveform as illustrated in FIG. 5.

The first output signal OUT1 transitions to the H logic in response to the first current I_{L1} becoming approximately 0. Consequently, the first switching element 51 is controlled to the ON state and the first current I_{L1} increases. The slope of the first current I_{L1} increases depending on the level of the AC voltage Vac. When the level of the ramp signal reaches the level of the PI signal, the first output signal OUT1 transitions to the L logic and the first switching element 51 is in the OFF state. Consequently, the first current I_{L1} decreases. When the first current I_{L1} becomes approximately 0, the first switching element 51 is controlled to the ON state again. Repeating such operations generates the first current I_{L1} as illustrated in FIG. 2.

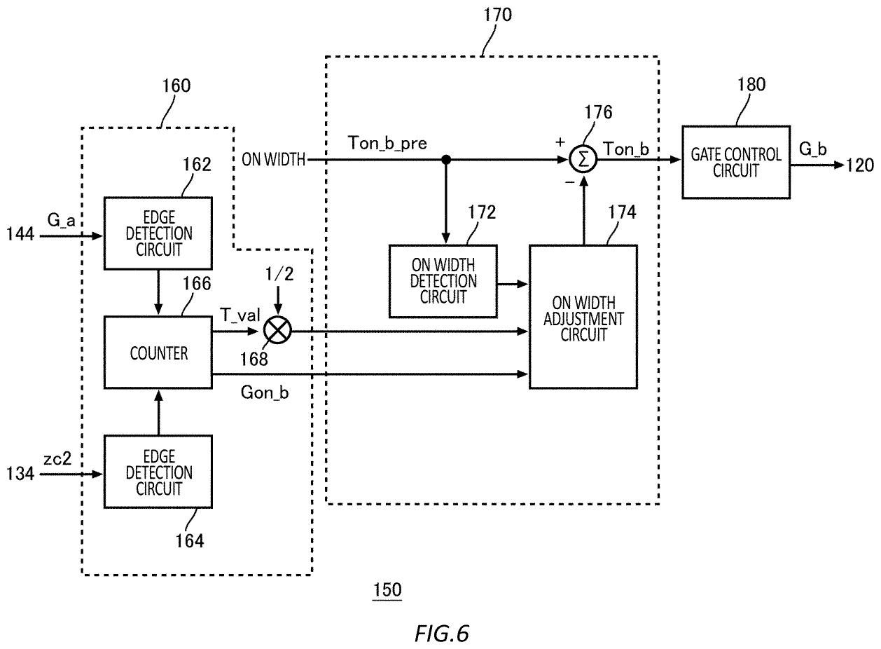

FIG. 6 is a block diagram illustrating an example of the second control signal generation unit 150. The second control signal generation unit 150 in the present example has a phase detection circuit 160, a phase compensation circuit 170, and a gate control circuit 180.

The phase detection circuit 160 generates the phase difference signal indicating the phase difference between the first current I_{L1} and the second current I_{L2}. The phase difference signal may be the time difference between the timing when the first current I_{L1} starts to increase and the timing when the second current I_{L2} starts to increase. The phase detection circuit 160 may detect a phase difference in the current waveforms themselves between the first current I_{L1} and the second current I_{L2} or may detect the phase difference from other signals. For example, the phase detection circuit 160 may detect the phase difference based on the first control signal G_a and the comparison result signal zc2.

The phase detection circuit 160 in the present example has an edge detection circuit 162, a counter 166, an edge detection circuit 164, and a multiplier 168. The edge detection circuit 162 detects the rising edge in the first control signal G_a. In other words, the edge detection circuit 162 detects the timing when the first switching element 51 is turned on.

The edge detection circuit 164 detects the rising edge in the comparison result signal zc2. In other words, the edge detection circuit 162 detects the timing when the second switching element 52 is turned on. Instead of the comparison result signal zc2, the second control signal G_b may be input to the phase detection circuit 160. In this case, the phase detection circuit 160 detects the rising edge in the second control signal G_b.

The counter 166 measures the time interval between the rising edges in the first control signal G_a. In other words, the counter 166 measures the time interval between the timings when the first switching element 51 is turned on. The counter 166 may measure the time interval by counting the pulses of the clock signal that is input within a period from the rising edge to the next rising edge in the first control signal G_a. The counter 166 outputs the interval signal T_val indicating the magnitude of the time interval.

The counter 166 measures time interval from the rising edge in the first control signal G_a to the rising edge in the comparison result signal zc2. In other words, the counter 166 measures the phase difference between the timing when the first switching element 51 is turned on and the timing when the second switching element 52 is turned on. The counter 166 outputs the phase difference signal Gon_b indicating the magnitude of the phase difference. If the phase difference between the first current I_{L1} and the second current I_{L2} is 180 degrees, the magnitude of the phase difference signal Gon_b is half the magnitude of the interval signal T_vak. The phase detection circuit 160 may detect the phase difference between the first control signal G_a controlling the switching of the first switching element 51 and the second control signal G_b controlling the switching of the second switching element 52 to generate the phase difference signal Gon_b.

The multiplier 168 outputs the signal with half the magnitude of the interval signal T_vak. The multiplier 168 in the present example outputs the digital value of the interval signal T_vak by multiplying it by ½.

The phase compensation circuit 170 adjusts the second phase for the operation of the second switching element 52 based on the output from the multiplier 168 obtained by multiplying the interval signal T_vak by ½, the phase difference signal Gon_b, and the duration of the ON period of the second switching element 52. The phase compensation circuit 170 adjusts the second phase for the operation of the second switching element 52 relative to the first phase for the operation of the first switching element 51. For example, the first phase is the timing when the first switching element 51 is turned on, and the second phase is the timing when the second switching element 52 is turned on. Alternatively, the first phase is the phase for the rising edge of the first control signal G_a, and the second phase is the phase for the rising edge of the second control signal G_b. Alternatively, the first phase is the phase for the rising edge of the first output signal OUT1, and the second phase is the phase for the rising edge of the second output signal OUT2. The phase compensation circuit 170 may adjust the second phase such that the relative phase of the second phase to the first phase becomes a predetermined target value. The phase compensation circuit 170 may adjust the phase difference of the second phase relative to the first phase by adjusting the second phase without adjusting the first phase. For example, the phase compensation circuit 170 adjusts the second phase such that the phase difference between the first phase and the second phase becomes 180 degrees.

The phase compensation circuit 170 in the present example adjusts the second phase by adjusting the ON period (that is, the ON width) of the second switching element 52. When the ON period of the second switching element 52 in a certain cycle becomes shorter, the second switching element 52 is turned off earlier in the cycle and thus the second phase after the cycle relatively advances in the time axis. On the other hand, when the ON period of the second switching element 52 in a certain cycle becomes longer, the second switching element 52 is turned off later and thus the second phase after the cycle relatively delays in the time axis. Through such controls, the second phase can be adjusted.

The phase compensation circuit 170 adjusts the second phase depending on the difference between the relative phase of the second phase to the first phase and the target value (for example, 180 degrees). To that end, the second phase is adjusted depending on the difference between the output from the multiplier 168 obtained by multiplying the interval signal T_vak by ½ and the phase difference signal Gon_b. However, a rapid change in the second phase disturbs the waveform of the input current that is input to the first inductor 21 and the second inductor 22, deteriorating the power factor. For example, when the difference between the relative phase and the target value is relatively high, attempting to eliminate the difference through the phase adjustment in one cycle of the second current I_{L2} leads to a large variation in the second phase in the cycle.

The phase compensation circuit 170 in the present example restricts the phase adjustment amount of the second phase in each cycle of the second current I_{L2} based on the duration of the ON period of the second switching element 52. The phase compensation circuit 170 may increase the phase adjustment amount of the second phase in each cycle as the ON period in each cycle becomes longer. When the ON period of the second switching element 52 is short, attempting to significantly adjust the second phase increases the ratio of the variation in the ON period to the duration of the original ON period too much, increasing the disturbance to the waveform of the input current to the inductor. In particular, when the ON period is short, attempting to significantly decrease the ON period decreases the remaining ON period too much, increasing the disturbance in the waveform of the input current.

In contrast, restricting the phase adjustment amount of the second phase depending on the ON period of the second switching element 52 can suppress the disturbance in the waveform of the input current and improve the power factor. The second phase may be gradually adjusted depending on the difference between the relative phase of the second phase to the first phase and the target value over several cycles of the second current I_{L2}.

The phase compensation circuit 170 in the present example has an ON width detection circuit 172, an ON width adjustment circuit 174, and a calculation unit 176. The ON width detection circuit 172 detects the duration of the ON period of the second switching element 52 in the cycle. The ON width detection circuit 172 may accept the ON period signal Ton_b_pre specifying the ON period of the second switching element 52. The duration of the ON period of the second switching element 52 specified in the ON period signal Ton_b_pre may be the same as the duration of the ON period of the first switching element 51. The duration of the ON period of the second switching element 52 specified in the ON period signal Ton_b_pre may be set in a similar method to that for the duration of the ON period of the first switching element 51 described in FIG. 4 and FIG. 5.

The ON width adjustment circuit 174 adjusts the duration of the ON period of the second switching element 52 with the duration of the ON period detected by the ON width detection circuit 172, the output from the multiplier 168 obtained by multiplying the interval signal T_vak by ½, and the ON width adjustment amount depending on the phase difference signal Gon_b. As described above, the ON width adjustment circuit 174 may adjust the second phase such that the relative phase of the second phase to the first phase indicated in the phase difference signal Gon_b becomes a predetermined target value. The ON width adjustment circuit 174 restricts the ON width adjustment amount for an ON period of the second switching element 52 depending on the duration of the ON period. The ON width adjustment circuit 174 increases the ON width adjustment amount as the ON period becomes longer and it decreases the ON width adjustment amount as the ON period becomes shorter. The ON width adjustment circuit 174 outputs, to the calculation unit 176, the signal indicating the ON width adjustment amount that is restricted depending on the duration of the ON period.

The calculation unit 176 adds or subtracts the ON width adjustment amount calculated by the ON width adjustment circuit 174 to or from the ON period signal Ton_b_pre to adjust the duration of the ON period of the second switching element 52. The calculation unit 176 outputs the ON phase signal Ton_b indicating the duration of the ON period after the adjustment.

The gate control circuit 180 outputs the second control signal G_b based on the ON phase signal Ton_b. The gate control circuit 180 may output the second control signal G_b that indicates the H logic until the ON period indicated by the ON phase signal Ton_b elapses since the timing of the rising edge in the comparison result signal zc2 and indicates the L logic after the ON period elapses.

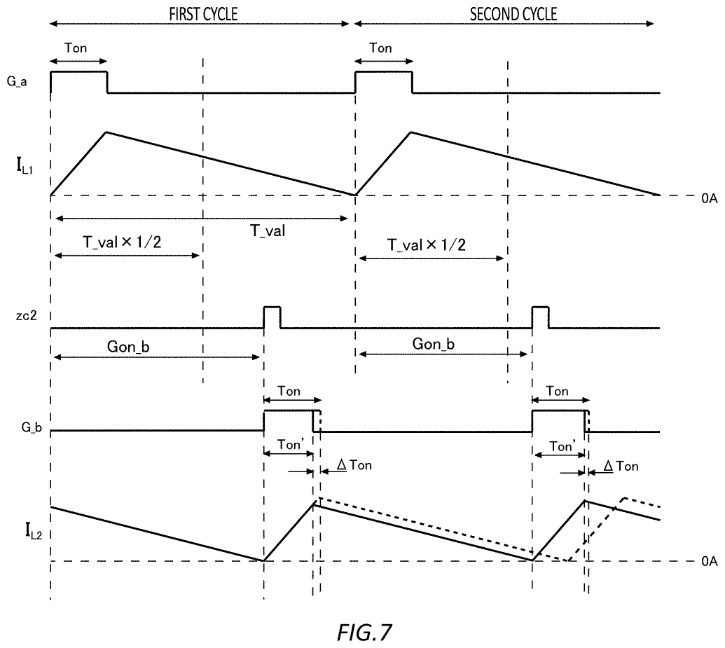

FIG. 7 is a timing chart illustrating an exemplary operation of the second control signal generation unit 150. The horizontal axis in FIG. 7 indicates the time and the vertical axis indicates the level of each signal. In FIG. 7, one cycle is defined as the period from the rising edge in the first control signal G_a to the next rising edge.

When the first current I_{L1} becomes approximately 0 A, the first control signal G_a becomes the H logic and the first switching element 51 becomes the ON state. The first control signal G_a maintains the H logic during a predetermined ON period Ton and transitions to the L logic after the ON period Ton elapses. Consequently, the increase and decrease in the first current I_{L1} is repeated. The edge detection circuit 162 detects the time interval T_val between the rising edges in the first control signal G_a.

The comparison result signal zc2 indicates the H logic in a pulse-like manner when the second current I_{L2} becomes approximately 0 A. Consequently, the second control signal G_b becomes the H logic and the second current I_{L2} increases. When there is no adjustment of the ON width by the ON width adjustment circuit 174, the second control signal G_b maintains the H logic during a predetermined ON period Ton and transitions to the H logic after the ON period Ton elapses. In this case, as indicated in the waveform with the dotted line, the periodic time of the second current I_{L2} and the periodic time of the first current I_{L1} remain the same. Accordingly, the phase difference between the first current I_{L1} and the second current I_{L2} does not change.

As described above, the ON width adjustment circuit 174 adjusts the ON period Ton of the second control signal G_b by the ON width adjustment amount ΔTon depending on the phase difference between the first current I_{L1} and the second current I_{L2} (in the present example, the difference between the magnitude of the interval signal T_val×½ and the magnitude of the phase difference signal Gon_b). In FIG. 7, the ON period after the adjustment is referred to as Ton′. In the example in FIG. 7, the phase difference signal Gon_b is greater than half the interval signal T_val in each cycle. In this case, the ON width adjustment circuit 174 advances the phase of the second current I_{L2} by shortening the ON width Ton of the second control signal G_b. Consequently, the magnitude of the phase difference signal Gon_b can be made close to the magnitude of the interval signal T_val×½.

As described in FIG. 6, the ON width adjustment circuit 174 may restrict the magnitude of the ON width adjustment amount ΔTon based on the set value Ton of the ON period of the second control signal G_b in the cycle. Such a control prevents the rapid change in the phase of the second current I_{L2} and also prevents the ON period after the adjustment Ton′ from becoming too small. The set value Ton may be the same as the ON period Ton of the first control signal G_a in the cycle.

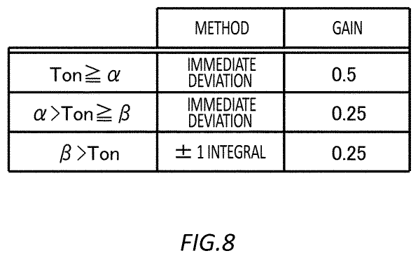

FIG. 8 is a diagram illustrating an example of the restriction on an ON width adjustment amount ΔTon in an ON width adjustment circuit 174. The ON width adjustment circuit 174 in the present example increases the ON width adjustment amount ΔTon as the ON period of the second control signal G_b becomes longer. The ON width adjustment circuit 174 may restrict the ON width adjustment amount ΔTon based on the set value Ton of the ON period in the cycle or may restrict the ON width adjustment amount ΔTon based on the actual ON period Ton in the previous cycle.

The ON width adjustment circuit 174 in the present example calculates the ON width adjustment amount ΔTon by multiplying the compensation reference value depending on the magnitude of the phase difference indicated in the phase difference signal Gon_b by a gain that increases as the ON period Ton becomes longer. The compensation reference value is set to become a higher value as the phase difference becomes larger. The compensation reference value may be based on the difference between the magnitude of the interval signal T_val×½ and the magnitude of the phase difference indicated in the phase difference signal Gon_b. The compensation reference value may be an ON width adjustment amount needed to eliminate the phase difference with one adjustment of the ON width.

The gain by which the compensation reference value is multiplied may be a value less than 1. The gain by which the compensation reference value is multiplied may be 0.5 or less. The ON width adjustment circuit 174 increases the gain as the ON period Ton becomes longer. Consequently, the ON width adjustment amount ΔTon can be restricted depending on the magnitude of the ON period Ton. In the example in FIG. 8, the gain for the ON period Ton equal to or greater than the period α is 0.5 and the gain for the ON period Ton less than the period α is 0.25. Although, in the example in FIG. 8, the gain is changed in a stepped manner with two steps, the gain may be changed with more steps.

The ON width adjustment circuit 174 may calculate at least one of the upper limit value or the lower limit value of the ON width adjustment amount ΔTon depending on the duration of the ON period Ton. The ON width adjustment circuit 174 may have a preset table or formula indicating the relationship between the duration of the ON period Ton and the upper limit value and lower limit value. The upper limit value of the ON width adjustment amount ΔTon may be 0.5 times the ON period Ton or less. The lower limit value of the ON width adjustment amount ΔTon may be 0.05 times the ON period Ton or more or may be 0.1 times the ON period Ton or more. The lower limit value of the ON width adjustment amount ΔTon may be the duration of one periodic time of the clock signal that is input to the second control signal generation unit 150. The ON width adjustment circuit 174 may calculate the ON width adjustment amount ΔTon within a range determined by the calculated upper limit value and lower limit value.

The ON width adjustment circuit 174 may change the adjustment manner for the second phase depending on the magnitude of the ON period Ton. The ON width adjustment circuit 174 in the present example may change the adjustment manner depending on whether the ON period Ton is equal to or more than a predetermined reference value or less than the reference value. In the example of FIG. 8, the period β corresponds to the reference value. The period β is smaller than the period α.

The ON width adjustment circuit 174 may use an immediate deviation method, which reflects the phase difference between the first phase and the second phase to the ON width adjustment amount ΔTon in the cycle or the next cycle if the ON period Ton is equal to or greater than the reference value. In the immediate deviation method, the phase difference between the first phase and the second phase may be reflected in the ON width adjustment amount ΔTon in the second subsequent cycle or a later cycle. The ON width adjustment circuit 174 may determine the ON width adjustment amount ΔTon in the integral manner if the ON period Ton is less than the reference value.

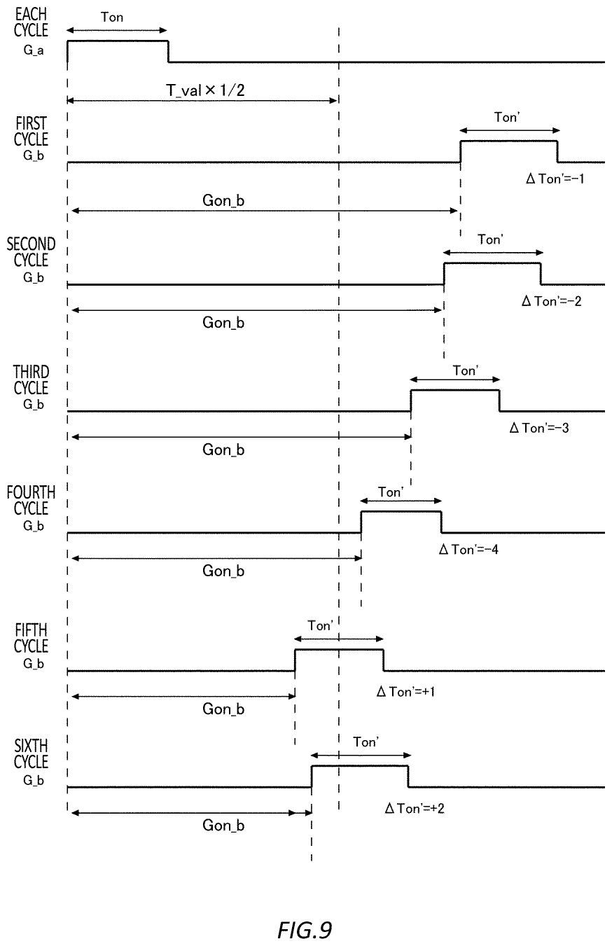

FIG. 9 is a diagram illustrating an integral manner. The second control signal generation unit 150 in the present example can set the ON width adjustment amount ΔTon to an integer multiple of a predetermined minimum set value. The minimum set value may be a duration of one periodic time of the clock signal that is input to the second control signal generation unit 150.

In the example in FIG. 9, the magnitude of the ON width adjustment amount ΔTon is indicated as a multiple of the minimum set value. For example, the description of ΔTon=−1 indicates that the absolute value of the ON width adjustment amount ΔTon is one time the minimum set value. The description of ΔTon=−2 indicates that the absolute value of the ON width adjustment amount ΔTon is two times the minimum set value. In addition, for the ON width adjustment amount ΔTon with the negative sign, the ON width adjustment amount ΔTon is subtracted from the set value Ton of the ON period, and, for the ON width adjustment amount ΔTon with the positive sign, the ON width adjustment amount ΔTon is added to the set value Ton of the ON period. For example, for the description of ΔTon=−1, the ON width adjustment amount ΔTon that is one time the minimum set value is subtracted from the set value Ton of the ON period. In this case, the ON period after the adjustment Ton′ is shorter than the set value of the ON period Ton.

FIG. 9 illustrates the waveform of the first control signal G_a and the waveform of the second control signal G_b in the first to sixth cycles side by side. Since the waveform of the first control signal G_a is common among each cycle, only the waveform corresponding to one cycle is shown. As described above, the second control signal generation unit 150 adjusts the ON period of the second control signal G_b such that the timing of the rising edge (corresponding to the second phase) in the second control signal g_b matches the timing at the midpoint in each cycle of the first control signal G_a (the position of T_val×½).

In the first cycle, the rising edge of the second control signal G_b is delayed with respect to the timing at T_val×½. Accordingly, the second control signal generation unit 150 shortens the ON period of the second control signal G_b and relatively advances the second phase of the second control signal G_b relative to the first phase of the first control signal G_a.

As shown in the waveform of the first cycle, when the duration of the ON period Ton is less than the set period β, the ON width adjustment circuit 174 may adjust the ON period of the second control signal G_b by the ON width adjustment amount of the minimum set value (ΔTon=−1). Consequently, the rapid variation in the ON period Ton can be suppressed.

As shown in the waveforms for the second cycle to the fourth cycle, when adjusting the ON period Ton in the same direction on the time axis as that of the adjustment in the previous cycle, the ON width adjustment circuit 174 may add the minimum set value to the absolute value of the ON width adjustment amount ΔTon while maintaining the sign of the ON width adjustment amount ΔTon used for the adjustment in the previous cycle. For example, in the second cycle, similarly to the first cycle, the ON period Ton of the second control signal G_b is adjusted to be shorter in the time axis. In this case, the sign of the ON width adjustment amount ΔTon in the second cycle is maintained to be the same as the sign of the ON width adjustment amount ΔTon in the first cycle (in the present example, negative). In addition, the minimum set value “1” is added to the absolute value “1” of the ON width adjustment amount ΔTon in the first cycle to obtain the absolute value “2” of the ON width adjustment amount ΔTon in the second cycle. Through such a process, the adjustment of the phase of the second current I_{L2} can be accelerated by gradually increasing the absolute value of the ON width adjustment amount ΔTon when the ON period Ton is adjusted in the same direction on the time axis.

As shown in the waveforms of the fourth cycle and the fifth cycle, when adjusting the ON period Ton in the direction on the time axis opposite to that of the adjustment in the previous cycle, the ON width adjustment circuit 174 resets the absolute value of the ON width adjustment amount ΔTon to the minimum set value while inverting the sign of the ON width adjustment amount ΔTon used for the adjustment in the previous cycle. For example, in the fourth cycle, the ON period Ton of the second control signal G_b is adjusted to be shorter in the time axis, while, in the fifth cycle, the ON period Ton is adjusted to be longer in the time axis. In this case, in the fifth cycle, the sign of the ON width adjustment amount ΔTon is inverted to positive and also the absolute value of the ON width adjustment amount ΔTon is reset to the minimum set value “1”. Through such a process, the adjustment of the phase of the second current I_{L2} can be accelerated by settling the ON width adjustment amount ΔTon early.

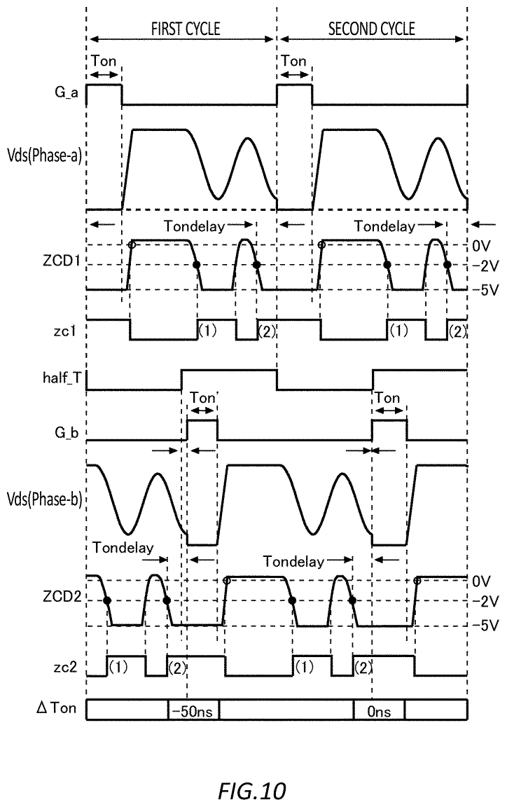

FIG. 10 is a timing chart illustrating an example of each signal in the control circuit 100 in more detail. In FIG. 10, the waveforms of the first current I_{L1} and the second current I_{L2} are omitted. While the first control signal G_a is the H logic, the first switching element 51 is in the ON state and the first current I_{L1} increases. While the first switching element 51 is in the ON state, the source-drain voltage Vds (Phase-a) of the first switching element 51 is approximately 0 V. When the first control signal G_a transitions to the L logic, the first current I_{L1} decreases. The Vds (Phase-a) maintains the high voltage until the first current I_{L1} becomes approximately 0. When the first current I_{L1} becomes approximately 0, the Vds (Phase-a) decreases from the high voltage. The Vds (Phase-a) in the present example resonates depending on the resonant frequency of the circuit after starting to decrease from high voltage. Although not shown in FIG. 10, the first current I_{L1} in the present example also resonates.

The voltage ZCD1 has a similar waveform to that of Vds (Phase-a). The comparison result signal zc1 that is output from the comparator circuit 114 indicates the H logic in the period when the voltage ZCD1 is less than a predetermined reference voltage (−2 V in FIG. 10) and indicates the L logic in the period when the voltage ZCD1 is equal to or greater than the reference voltage. With the resonant waveform of Vds (Phase-a), the comparison result signal zc1 in the present example has a plurality of times of rising edges in one cycle.

The comparator circuit 114 may select and output any rising edge among the rising edges in the comparison result signal zc1 in one cycle as the timing when the first current I_{L1} becomes approximately 0. In the example in FIG. 10, the comparator circuit 114 selects and outputs the second rising edge (2) in the comparison result signal zc1 as the timing when the first current I_{L1} becomes approximately 0.

The rising edge of the comparison result signal zc1 that is output from the comparator circuit 114 is delayed by a predetermined delay amount Tondelay by the delay element 132 and is input to the set reset latch circuit 144. Consequently, the first control signal G_a transitions to the H logic and the next cycle is started.

The source-drain voltage Vds (Phase-b), the voltage ZCD2, and the comparison result signal zc2 of the second switching element 52 have similar waveforms to the source-drain voltage Vds (Phase-a), the voltage ZCD1, and the comparison result signal zc1 of the first switching element 51.

In FIG. 10, the signal indicating half the interval of the rising edges in the first control signal Ga_b is referred to as half_T. The signal half_T is a signal that has a rising edge at the midpoint of each cycle in the first control signal Ga_b and has a falling edge at the boundary between each cycle. The signal half_T corresponds to the time interval T_val×½ that is output from the multiplier 168.

In the present example, in the first cycle, the rising edge of the second control signal G_b is delayed with respect to the rising edge of the signal half_T. The phase compensation circuit 170 sets the adjustment amount ΔTon such that the delay decreases. In the present example, −50 ns is set as the adjustment amount ΔTon.

In the present example, the calculation unit 176 adds the adjustment amount ΔTon set in each cycle to the set value Ton of the ON period in the cycle. In the present example, since the adjustment amount ΔTon in the first cycle is a negative value, the ON period after the adjustment Ton′ in the first cycle is shorter than the ON period Ton. Consequently, the phase of the rising edge in the second control signal G_b (the second phase) advances and the phase difference from the rising edge of the signal half_T decreases. In the present example, in the second cycle, the phase difference between the rising edge of the second control signal G_b and the rising edge of the signal half_T is approximately zero.

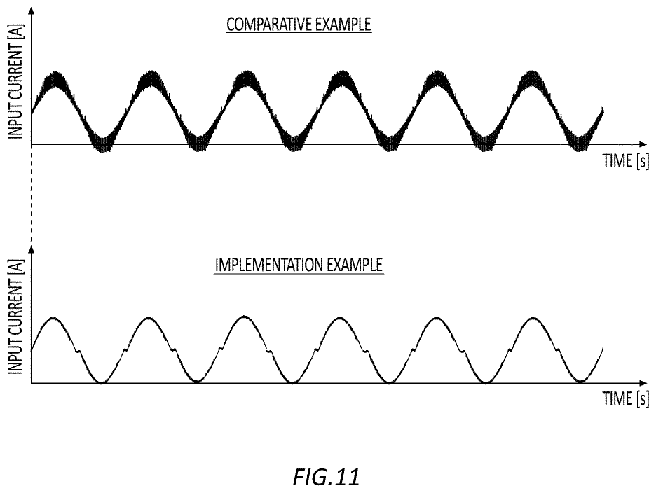

FIG. 11 illustrates an example of a time waveform of an input current in an implementation example in which the magnitude of the adjustment amount ΔTon is restricted depending on an ON width Ton and a comparative example in which it is not restricted. The input current is a current that is input from the full-wave rectifying circuit 14 to the first inductor 21 and the second inductor 22.

As illustrated in FIG. 11, in the comparative example, the input current is greatly disturbed especially at the high phase angle (that is, near the peak of the waveform). In contrast, in the implementation example, since the rapid change in the ON width is suppressed, the input current disturbance is suppressed. Accordingly, in the implementation example, both the suppression of the input current disturbance and the improvement of the response characteristics can be achieved. This tendency remains the same even when the amplitude of the AC voltage Vac is changed.

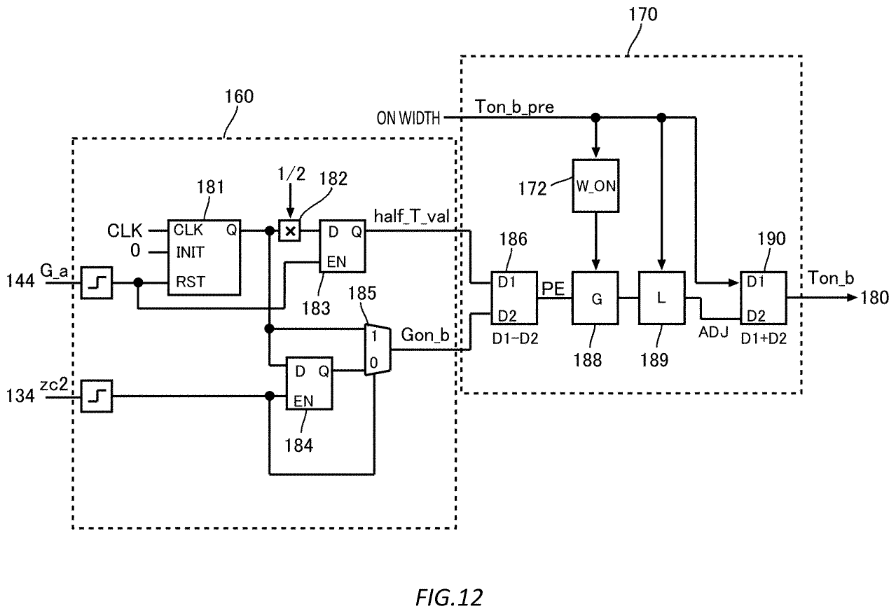

FIG. 12 is a diagram illustrating another configuration example of the phase detection circuit 160 and the phase compensation circuit 170. The phase detection circuit 160 and the phase compensation circuit 170 may have similar functions to those in the example illustrated in FIG. 6.

Similarly to the example in FIG. 6, the phase detection circuit 160 receives the first control signal G_a for controlling the switching of the first switching element 51, detects the ON interval T_val at which the first switching element 51 is turned on, based on the first control signal G_a, and outputs the value of half_T_val, which is the half value of the ON interval T_val. In addition, the phase detection circuit 160 outputs the phase difference signal Gon_b based on the first control signal G_a and the comparison result signal zc2.

The phase compensation circuit 170 calculates the phase error PE, which is the difference between the phase difference indicated by the phase difference signal Gon_b and the half of the ON interval (half_T_val), and adjusts the second phase, at which the second switching element 52 is turned on, based on the phase error PE. The phase compensation circuit 170 in the present example adjusts the second phase by adjusting the ON width Ton_b of the second switching element 52 based on the phase error PE.

The phase detection circuit 160 in the present example has a counter 181, a multiplier 182, a first latch unit 183, a second latch unit 184, and a selection unit 185. The counter 181 receives the first control signal G_a and a clock signal CLK. The counter 181 outputs the digital signal obtained by counting the number of pulses of the clock signal CLK. The counter 181 resets the output Q to the initial value INIT (for example, “0”) at the timing when the first switching element 51 is turned on. The counter 181 in the present example resets the output Q to the initial value at the timing of the rising edge in the first control signal G_a.

The multiplier 182 multiplies the output from the counter 181 by ½ for output. The multiplier 182 may perform a digital operation.

The first latch unit 183 receives the output from the multiplier 182 and the first control signal G_a. The first latch unit 183 outputs the first digital signal obtained by latching the output from the multiplier 182 at the timing when the first switching element 51 is turned on. The first digital signal indicates the magnitude of half of the ON interval T_val at which the first switching element 51 is turned on (half_T_val).

The second latch unit 184 receives the signal indicating the timing when the second switching element 52 is turned on (the comparison result signal zc2 in the present example) and the output from the counter 181. The second latch unit 184 outputs the second digital signal obtained by latching the output from the counter 181 at the timing when the second switching element 52 is turned on. The second digital signal indicates the magnitude of the phase difference Gon_b between the turn-on of the first switching element 51 and the turn-on of the second switching element 52.

The selection unit 185 selects and outputs either the output from the counter 181 or the output from the second latch unit 184 depending on the signal indicating the timing when the second switching element 52 is turned on (the comparison result signal zc2 in the present example). The selection unit 185 may select the output from the counter 181 from the timing when the second switching element 52 is turned on until one periodic time of the clock signal CLK elapses. The selection unit 185 may select the output from the second latch unit 184 in another period. The selection unit 185 in the present example selects the output from the counter 181 during the period when the comparison result signal zc2 indicates the H logic, and it selects the output from the second latch unit 184 during the period when the comparison result signal zc2 indicates the L logic.

As described above, the second digital signal that is output from the second latch unit 184 indicates the magnitude of the phase difference Gon_b. However, since the second latch unit 184 or the like operates according to the clock signal CLK, a delay corresponding to one clock occurs from when the output from the counter 181 becomes the value indicating the phase difference Gon_b until the phase difference Gon_b is reflected in the output from the second latch unit 184. When the selection unit 185 is provided, the phase difference Gon_b can be output even during the delay period.

The phase compensation circuit 170 in the present example has a signed subtractor 186, an ON width detection circuit 172, a gain circuit 188, a limiter 189, and a signed adder 190. The function of the ON width detection circuit 172 is similar to that in the example in FIG. 6.

The signed subtractor 186 receives the first digital signal D1 indicating the magnitude of half the ON interval (half_T_val) and the second digital signal D2 indicating the magnitude of the phase difference Gon_b. The signed subtractor 186 calculates the signed phase error PE through a digital operation for the difference between the first digital signal D1 and the second digital signal D2 (D1−D2). The sign of positive and negative in the phase error PE changes depending on whether the first digital signal D1 is greater or less than the second digital signal D2. For example, the phase error PE indicates the positive value when the first digital signal D1 is greater than the second digital signal D2, and the phase error PE indicates the negative value when the first digital signal D1 is smaller than the second digital signal D2.

Depending on the reference value of the ON period of the second switching element 52 (Ton_b_pre), the gain circuit 188 adjusts the gain by which the phase error PE is multiplied. The gain circuit 188 may multiply the phase error PE by a higher gain as the reference value of the ON period becomes higher. The gain by which the gain circuit 188 multiplies may be similar to that in the example described in FIG. 8.

Depending on the reference value of the ON period of the second switching element 52 (Ton_b_pre), the limiter 189 restricts the ON width adjustment amount ADJ that is input by the gain circuit 188 to the signed adder 190. Note that the ON width adjustment amount ADJ is a signed digital value. For example, the limiter 189 may restrict the ON width adjustment amount ADJ to be in the range equal to or more than-0.5 times and equal to or less than 0.5 times the reference value of the ON period (Ton_b_pre). If the output from the gain circuit 188 is outside the range, the limiter 189 may clamp the value of the ON width adjustment amount ADJ to the upper limit value or lower limit value of the range. Restricting the value of the ON width adjustment amount ADJ can prevent the ON period of the second switching element 52 from becoming 0 or less or the ON interval T_val or more.

The signed adder 190 receives the reference value of the ON period of the second switching element 52 (Ton_b_pre) and the ON width adjustment amount ADJ depending on the phase error PE that is output from the signed subtractor 186. The signed adder 190 adds the ON width adjustment amount ADJ to the reference value to output the ON phase signal Ton_b. The ON phase signal Ton_b is input to the gate control circuit 180 shown in FIG. 6.

The arrangement in the present example can also precisely adjust the timing when the second switching element 52 is turned on. Note that the ON width detection circuit 172 and the gain circuit 188 may be omitted. In addition, although the multiplier 182 is used in the present implementation example, any calculation unit that halves the numerical value of the received digital data output from the counter 181 may be used, and the multiplier 182 may be a shifter that shifts one bit data by one bit or a divider that divides by 2.

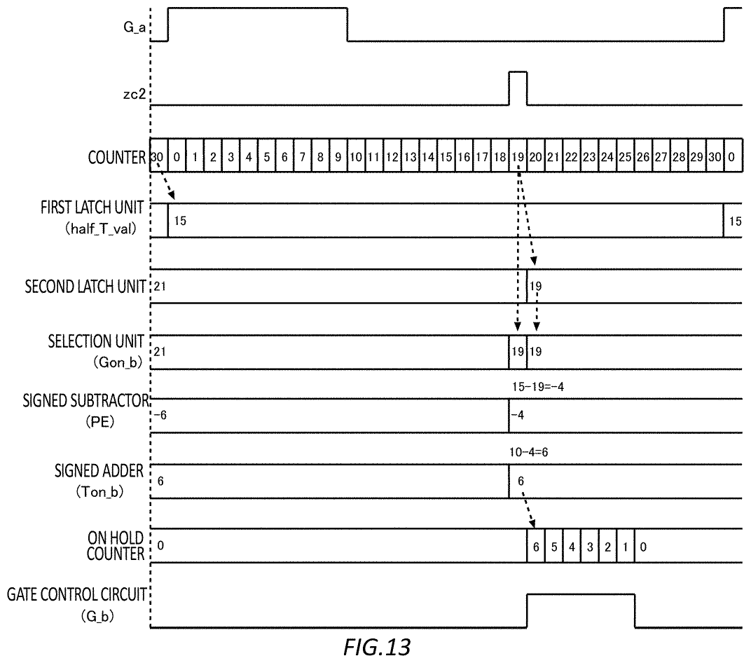

FIG. 13 is a timing chart illustrating an exemplary operation of the phase detection circuit 160 and the phase compensation circuit 170 in the example in FIG. 12. In the present example, Ton_b_pre is “10” and the gain in the gain circuit 188 is “1”.

The output from the counter 181 is reset to the initial value “0” at the timing of the rising edge in the first control signal G_a and increases by “1” for each pulse of the clock signal CLK. The output value “30” from the counter 181 in the periodic time immediately before the rising edge in the first control signal G_a corresponds to the ON interval T_val of the first switching element 51.

The first latch unit 183 accepts the output value “15” from multiplier 182 (half the output value “30” from the counter 181) at the timing of the rising edge in the first control signal G_a for output. Consequently, the first latch unit 183 outputs half the ON interval of the first switching element 51 (half_T_val). The output from the first latch unit 183 is maintained until the next rising edge in the first control signal G_a.

The second latch unit 184 accepts the output value “19” from the counter 181 at the timing of the rising edge in the comparison result signal zc2 for output. Consequently, the second latch unit 184 outputs the phase difference Gon_b of the turn-on between the first switching element 51 and the second switching element 52. The output from the second latch unit 184 is maintained until the next rising edge of the comparison result signal zc2. Note that the output value “21” from the second latch unit 184 exemplifies the value of the phase difference Gon_b of the previous cycle and does not affect the process of the current cycle described in FIG. 13. The same applies to the other parameters indicated below the second latch unit 184.

The selection unit 185 selects the output value “19” from the counter 181 for output during the period when the comparison result signal zc2 indicates the H logic, and it selects the output value “19” from the second latch unit 184 for output during the period when the comparison result signal zc2 indicates the L logic. Consequently, the selection unit 185 outputs an appropriate phase difference Gon_b in all the periods.

The signed subtractor 186 calculates the difference between the output value from the first latch unit 183 and the output value from the second latch unit 184. The output from the signed subtractor 186 is updated at the timing of the pulse of the comparison result signal zc2, for example. In the example in FIG. 13, the phase error PE that is output from the signed subtractor 186 at the timing is 15−19=−4. If the phase error PE is negative, it indicates that the timing for the turn-on of the second switching element 52 is delayed with respect to the midpoint of the ON interval of the first switching element 51.

The signed adder 190 receives the ON width adjustment amount ADJ depending on the phase error PE. In the present example, the gain in the gain circuit 188 is “1”. In addition, the value obtained by multiplying the phase error PE by the gain is within a restriction range in the limiter 189. Accordingly, the signed adder 190 receives the same ON width adjustment amount ADJ as the phase error PE. The signed adder 190 outputs the ON phase signal Ton_b “6”, which is obtained by adding the signed value “−4” of the ON width adjustment amount ADJ to the Ton_b_pre “10”. The magnitude of the ON phase signal Ton_b indicates the ON width for the current turn-on of the second switching element 52.

The gate control circuit 180 controls the ON width of the second switching element 52 depending on the ON phase signal Ton_b. The gate control circuit 180 in the present example may have an ON hold counter that decrements the value of the ON phase signal Ton_b by “1” from “6” to the reference value “0” according to the periodic time of the clock signal. The gate control circuit 180 sets the second control signal G_b to the H logic during the period from when the ON hold counter starts counting until the count value becomes the reference value “0”, and sets it to the L logic during the other periods. Consequently, the phase of the switching of the second switching element 52 can be adjusted by adjusting the ON width of the second switching element 52 depending on the phase error PE. In the present example, the timing for the next turn-on of the second switching element 52 can be advanced, as described in FIG. 7 or the like, by shortening the ON width of the second switching element 52.

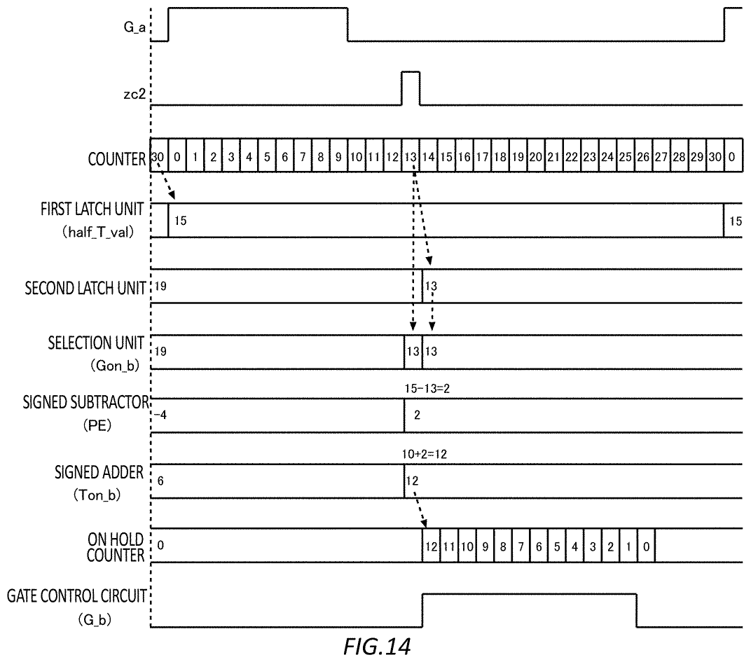

FIG. 14 is a timing chart illustrating another exemplary operation of the phase detection circuit 160 and the phase compensation circuit 170. Although the operation for the case where the timing for the turn-on of the second switching element 52 is later than the reference timing is described in the example in FIG. 13, the example in FIG. 14 indicates the example where the timing for the turn-on of the second switching element 52 is earlier than the reference timing.

In the present example, the phase difference “13” detected by the second latch unit 184 is smaller than half the ON period half_T_val “15” detected by the first latch unit 183. In this case, the signed subtractor 186 outputs the positive phase error “2”. The signed adder 190 outputs the ON phase signal Ton_b “12” obtained by adding the ON width adjustment amount ADJ “2” to the Ton_b_pre “10”. The gate control circuit 180 controls the ON width of the second switching element 52 depending on the ON phase signal Ton_b. In the present example, the timing for the next turn-on of the second switching element 52 can be delayed with a longer ON width of the second switching element 52.

In the present example, the signed subtractor 186 calculates the signed phase error PE through a digital operation. Accordingly, the phase for the turn-on of the second switching element 52 can be advanced or delayed with an easy process.

While the present invention has been described by way of the embodiments, the technical scope of the present invention is not limited to the above-described embodiments. It is apparent to persons skilled in the art that various alterations or improvements can be applied to the above-described embodiments. It is also apparent from the description of the claims that the embodiments to which such alterations or improvements is applied can be included in the technical scope of the present invention.

What is claimed is:

1. A control circuit which controls, for a power supply circuit, a switching operation of a first switching element, which controls a first current flowing through a first inductor, and a second switching element, which controls a second current flowing through a second inductor provided in parallel with the first inductor, the power supply circuit including the first switching element and the second switching element and outputting a sum current of a current depending on the first current and a current depending on the second current, the control circuit comprising:
a phase detection circuit which generates a phase difference signal which indicates a phase difference between the first current and the second current; and
a phase compensation circuit which adjusts a second phase, at which the second switching element operates, relative to a first phase, at which the first switching element operates, based on the phase difference signal and a duration of an ON period of the second switching element.

2. The control circuit according to claim 1, wherein the phase compensation circuit has:
an ON width detection circuit which detects a duration of an ON period of the second switching element; and
an ON width adjustment circuit which adjusts a duration of an ON period of the second switching element by an ON width adjustment amount depending on the duration of the ON period detected by the ON width detection circuit and the phase difference signal.

3. The control circuit according to claim 2, wherein the ON width adjustment circuit increases the ON width adjustment amount as the ON period becomes longer.

4. The control circuit according to claim 3, wherein the ON width adjustment circuit calculates the ON width adjustment amount by multiplying a compensation reference value depending on a magnitude of the phase difference indicated in the phase difference signal by a gain which increases as the ON period becomes longer.

5. The control circuit according to claim 3, wherein the ON width adjustment circuit calculates at least one of an upper limit value or a lower limit value of the ON width adjustment amount depending on the duration of the ON period, and calculates the ON width adjustment amount within a range determined by the upper limit value and the lower limit value which are calculated.

6. The control circuit according to claim 3, wherein the ON width adjustment amount can be set to an integer multiple of a minimum set value, and
the ON width adjustment circuit adjusts the ON period by the ON width adjustment amount of the minimum set value when the duration of the ON period is less than a set reference value.

7. The control circuit according to claim 2, wherein the ON width adjustment amount can be set to an integer multiple of a minimum set value, and
when adjusting the ON period in a same direction on a time axis as a previous adjustment, the ON width adjustment circuit adds the minimum set value to an absolute value of the ON width adjustment amount while maintaining a sign of the ON width adjustment amount used for the previous adjustment.

8. The control circuit according to claim 7, wherein, when adjusting the ON period in an opposite direction on the time axis to the previous adjustment, the ON width adjustment circuit resets an absolute value of the ON width adjustment amount to the minimum set value while inverting a sign of the ON width adjustment amount used for the previous adjustment.

9. The control circuit according to claim 1, wherein the phase detection circuit detects a phase difference between a first control signal, which controls switching of the first switching element, and a second control signal, which controls switching of the second switching element, and generates the phase difference signal.

10. The control circuit according to claim 1, wherein the first switching element and the second switching element operate in a current critical mode.

11. The control circuit according to claim 1, wherein the phase detection circuit receives a first control signal, which controls switching of the first switching element, and detects an ON interval, at which the first switching element is turned on, based on the first control signal, and
the phase compensation circuit calculates a phase error between the phase difference and half the ON interval and adjusts the second phase based on the phase error.

12. The control circuit according to claim 11, wherein the phase compensation circuit has a signed subtractor which receives a first digital signal, which indicates half a magnitude of the ON interval, and a second digital signal, which indicates a magnitude of the phase difference, and calculates the phase error with a sign through a digital operation.

13. The control circuit according to claim 12, wherein the phase detection circuit has:
a counter which receives the first control signal and a clock signal, counts and outputs a number of pulses of the clock signal, and resets its output to an initial value at a timing when the first switching element is turned on;
a calculation unit which halves a value of an output from the counter;
a first latch unit which receives an output from the calculation unit and the first control signal and outputs the first digital signal obtained by latching an output from the calculation unit at a timing when the first switching element is turned on; and
a second latch unit which receives a signal indicating a timing at which the second switching element is turned on and an output from the counter, and outputs the second digital signal obtained by latching an output from the counter at a timing when the second switching element is turned on.

14. The control circuit according to claim 13, wherein the phase detection circuit further has a selection unit which selects and outputs either an output from the counter or an output from the second latch unit depending on a signal indicating a timing when the second switching element is turned on.

15. The control circuit according to claim 13, wherein the phase compensation circuit has a signed adder which receives a reference value of the ON period of the second switching element and an ON width adjustment amount depending on the phase error output by the signed subtractor, and adds the ON width adjustment amount to the reference value of the ON period.

16. The control circuit according to claim 15, wherein the phase compensation circuit has a limiter which restricts the ON width adjustment amount depending on the reference value of the ON period.

17. A power supply device comprising a power supply circuit and a control circuit,
wherein the power supply circuit includes:
a first inductor;
a first switching element which controls a first current flowing through the first inductor;
a second inductor provided in parallel with the first inductor; and
a second switching element which controls a second current flowing through the second inductor,
the power supply circuit outputs a sum current of a current depending on the first current and a current depending on the second current,
the control circuit controls switching operation of the first switching element and the second switching element for the power supply circuit, and
the control circuit includes:
a phase detection circuit which generates a phase difference signal indicating a phase difference between the first current and the second current; and
a phase compensation circuit which adjusts a second phase, at which the second switching element operates, relative to a first phase, at which the first switching element operates, based on the phase difference signal and a duration of an ON period of the second switching element.

18. A control circuit which controls, for a power supply circuit, a switching operation of a first switching element which controls a first current flowing through a first inductor and a second switching element which controls a second current flowing through a second inductor provided in parallel with the first inductor, the power supply circuit including the first switching element and the second switching element and outputting a sum current of a current depending on the first current and a current depending on the second current, the control circuit comprising:
a phase detection circuit which generates a phase difference signal which indicates a phase difference between the first current and the second current; and
a phase compensation circuit which adjusts a second phase, at which the second switching element operates, relative to a first phase, at which the first switching element operates, based on the phase difference signal,
wherein the phase detection circuit receives a first control signal which controls switching of the first switching element and detects an ON interval, at which the first switching element is turned on, based on the first control signal,
the phase compensation circuit calculates a phase error between the phase difference and half the ON interval and adjusts the second phase based on the phase error, and
the phase compensation circuit has a signed subtractor which receives a first digital signal, which indicates half a magnitude of the ON interval, and a second digital signal, which indicates a magnitude of the phase difference, and calculates the phase error with a sign through a digital operation.

19. The control circuit according to claim 18, wherein the phase detection circuit has:
a counter which receives the first control signal and a clock signal, counts and outputs a number of pulses of the clock signal, and resets its output to an initial value at a timing when the first switching element is turned on;
a calculation unit which halves an output from the counter;
a first latch unit which receives an output from the calculation unit and the first control signal and outputs the first digital signal obtained by latching an output from the calculation unit at a timing when the first switching element is turned on; and
a second latch unit which receives a signal indicating a timing at which the second switching element is turned on and an output from the counter, and outputs the second digital signal obtained by latching an output from the counter at a timing when the second switching element is turned on.

20. A power supply device comprising a power supply circuit and a control circuit,
wherein the power supply circuit includes:
a first inductor;
a first switching element which controls a first current flowing through the first inductor;
a second inductor provided in parallel with the first inductor; and
a second switching element which controls a second current flowing through the second inductor,
the power supply circuit outputs a sum current of a current depending on the first current and a current depending on the second current,
the control circuit controls switching operation of the first switching element and the second switching element for the power supply circuit,
the control circuit includes:
a phase detection circuit which generates a phase difference signal which indicates a phase difference between the first current and the second current; and
a phase compensation circuit which adjusts a second phase, at which the second switching element operates, relative to a first phase, at which the first switching element operates, based on the phase difference signal,
the phase detection circuit receives a first control signal which controls switching of the first switching element, and detects an ON interval, at which the first switching element is turned on, based on the first control signal,
the phase compensation circuit calculates a phase error between the phase difference and half the ON interval and adjusts the second phase based on the phase error, and
the phase compensation circuit has a signed subtractor which receives a first digital signal which indicates half a magnitude of the ON interval and a second digital signal which indicates a magnitude of the phase difference, and calculates the phase error with a sign through a digital operation.
